(19) United States
(12) Patent Application Publication
(10) Pub. No.: US 2025/0172936 A1
(43) Pub. Date: May 29, 2025

(54) INFORMATION PROCESSING APPARATUS AND INFORMATION PROCESSING METHOD

(71) Applicant: Panasonic Automotive Systems Co., Ltd., Kanagawa (JP)

(72) Inventor: Satoshi FUKUMOTO, Tokyo (JP)

(73) Assignee: Panasonic Automotive Systems Co., Ltd., Kanagawa (JP)

(21) Appl. No.: 19/038,101

(22) Filed: Jan. 27, 2025

Related U.S. Application Data
(63) Continuation of application No. PCT/JP2023/022532, filed on Jun. 19, 2023.

(30) Foreign Application Priority Data
Sep. 1, 2022 (JP) 2022-139085

(51) Int. Cl. G05D 1/226; B60W 30/06; B60W 30/14; B60W 50/14; G05D 1/227; G05D 1/644; G05D 1/65; G05D 107/13; G05D 109/10; G05D 111/30; H04B 17/318; H04W 4/44

(52) U.S. Cl. CPC G05D 1/226; B60W 30/06; B60W 30/146; B60W 50/14; G05D 1/2274; G05D 1/644; G05D 1/65; H04B 17/318; H04W 4/44; B60W 2050/146; B60W 2556/45; G05D 2107/13; G05D 2109/10; G05D 2111/32

(57) ABSTRACT

The information processing apparatus includes: a processor; and a memory having instructions that, when executed by the processor, cause the processor to perform operations comprising: performing communication with an external apparatus via a mobile communication network; performing determination of a strength of a received radio wave based on a current position of the vehicle and a radio wave intensity map, the received radio wave being a radio wave received by the vehicle, the radio wave intensity map indicating a radio wave intensity in the mobile communication network; and performing control according to at least one of a behavior of the vehicle and/or the communication of the vehicle based on a result of the determination.

### TECHNICAL FIELD

The present disclosure relates to an information processing apparatus and an information processing method.

### BACKGROUND ART

An automobile, a so-called connected car, which has an information and communication technology (ICT) function and constantly communicates with an external apparatus via a predetermined network is known.

### CITATION LIST

### Patent Literature

PTL 1
Japanese Patent Application Laid-Open No. 2022-109023

### SUMMARY OF INVENTION

### Technical Problem

However, there is room for improvement in connected cars.

An object of the present disclosure is to provide an information processing apparatus and an information processing method each of which has achieved further improvement.

### Solution to Problem

An information processing apparatus according to an aspect of the present disclosure is an information processing apparatus that configured to be mounted on a vehicle, the information processing apparatus comprising: a processor; and a memory having instructions that, when executed by the processor, cause the processor to perform operations comprising: performing communication with an external apparatus via a mobile communication network; performing determination of a strength of a received radio wave based on a current position of the vehicle and a radio wave intensity map, the received radio wave being a radio wave received by the vehicle, the radio wave intensity map indicating a radio wave intensity in the mobile communication network; and performing control according to at least one of a behavior of the vehicle and/or the communication of the vehicle based on a result of the determination.

An information processing method according to an aspect of the present disclosure is an information processing method that uses a mobile communication network between an information processing apparatus configured to be mounted on a vehicle and an external apparatus. The information processing method includes: performing determination of a strength of a received radio wave, which is received by the vehicle, based on a current position of the vehicle and a radio wave intensity map which indicates a radio wave intensity in the mobile communication network; and performing control according to at least one of a behavior of the vehicle and/or the communication of the vehicle based on a result of the determination.

### Advantageous Effects of Invention

According to the present disclosure, it is possible to provide an information processing apparatus and an information processing method each of which has achieved further improvement.

### BRIEF DESCRIPTION OF DRAWINGS

FIG. 1 is a block diagram illustrating an exemplary configuration of a communication system according to an embodiment of the present disclosure;

FIG. 2 is a diagram illustrating an exemplary hardware configuration of a computer included in each of an information processing apparatus and a server according to the embodiment of the present disclosure;

FIG. 3 is a flowchart illustrating exemplary operations of the information processing apparatus according to the embodiment of the present disclosure; and

FIG. 4 is a diagram schematically illustrating an exemplary display of a radio wave intensity map according to the embodiment of the present disclosure.

### DESCRIPTION OF EMBODIMENTS

Hereinafter, an embodiment of the present disclosure will be described in detail with reference to the accompanying drawings.

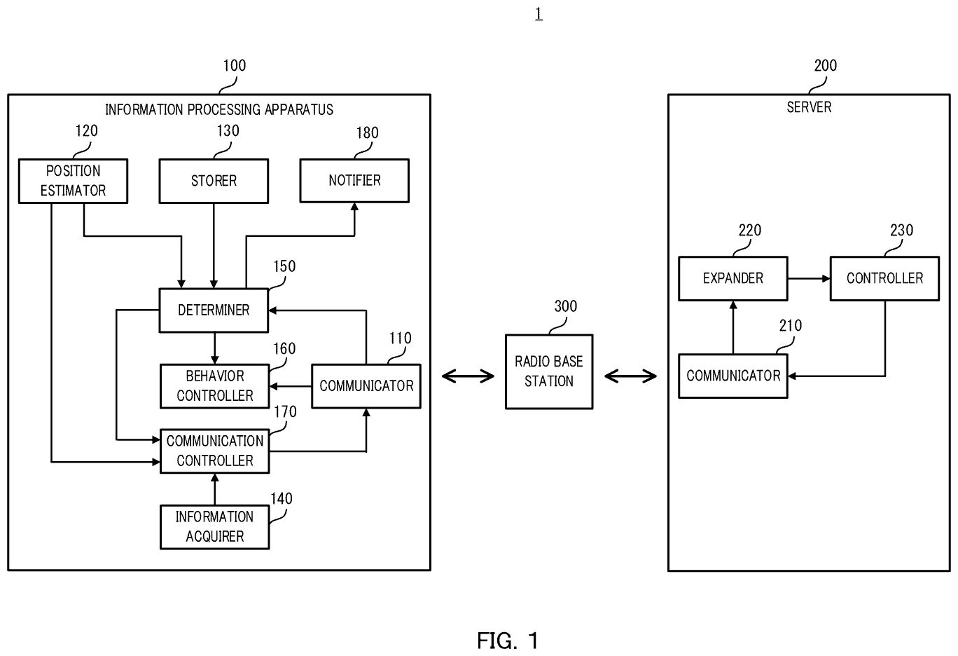

An exemplary configuration of communication system 1 according to the present embodiment will be described with reference to FIG. 1. FIG. 1 is a block diagram illustrating an exemplary configuration of communication system 1.

As illustrated in FIG. 1, communication system 1 includes: information processing apparatus 100 mounted on a vehicle (not illustrated); server 200 on a network; and radio base station 300 in a mobile communication network.

Examples of the mobile communication network include the 5th Generation Mobile Communication System (5G). Examples of server 200 include a low-latency cloud server or a Multi-access Edge Computing (MEC) server. Server 200 corresponds to an example of the external apparatus.

In the present embodiment, a case where the vehicle is a connected car capable of automatic driving, and an Advanced Driving Assistant System (ADAS) is realized by communication between information processing apparatus 100 and server 200 will be described as an example.

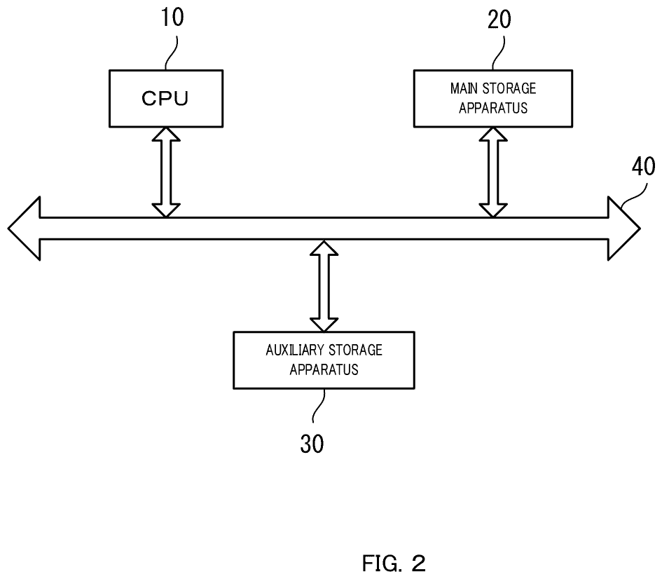

As illustrated in FIG. 2, each of information processing apparatus 100 and server 200 includes, as hardware, central processing unit (CPU) 10, main storage apparatus 20 such as a read only memory (ROM) and a random access memory (RAM), auxiliary storage apparatus 30 storing computer programs, such as a hard disk and a flash memory, and bus 40 connecting CPU 10, main storage apparatus 20, and auxiliary storage apparatus 30, for example.

The respective functions of information processing apparatus 100 and server 200 to be described later are implemented by CPU 10 developing a computer program read from auxiliary storage apparatus 30 to the RAM of main storage apparatus 20 and executing the program. Note that, the computer program may be provided to a user or the like by being recorded on a predetermined recording medium or through network distribution.

First, the functions of server 200 will be described.

As illustrated in FIG. 1, server 200 includes communicator 210, expander 220, and controller 230.

Communicator 210 is a device that transmits and receives information to and from information processing apparatus 100 via radio base station 300. Note that, for example, a cloud gateway may be applied as communicator 210.

For example, communicator 210 receives vehicle information from information processing apparatus 100. The vehicle information is, for example, information indicating the current position of a vehicle, the state of the vehicle, the peripheral situation of the vehicle, and/or the like (details thereof will be described later).

Further, for example, communicator 210 transmits instruction information to information processing apparatus 100. The instruction information is, for example, instruction information indicating an instruction for a behavior that a vehicle during automatic driving should take (details thereof will be described later). A vehicle executes automatic driving based on this instruction information.

Expander 220 is a device that expands (for example, decodes, decompresses, and/or the like) vehicle information received by communicator 210 and outputs the expanded vehicle information to controller 230.

Controller 230 is a device that controls communicator 210 such that communicator 210 determines, based on vehicle information and map information, a behavior that a vehicle should execute (an operation related to traveling, for example, acceleration/deceleration, steering, braking, and/or the like), and transmits instruction information indicating an instruction for the behavior to information processing apparatus 100. Note that, the instruction information may include information on a travel route based on the map information.

For example, controller 230 executes an ADAS application. Examples of the ADAS application include a theft prevention application for preventing vehicle theft, a home parking application for parking a vehicle at home, and a parking application for leaving or calling a vehicle.

Next, the functions of information processing apparatus 100 will be described.

As illustrated in FIG. 1, information processing apparatus 100 includes communicator 110, position estimator 120, storer 130, information acquirer 140, determiner 150, behavior controller 160, communication controller 170, and notifier 180.

Communicator 110 is a device that transmits and receives information to and from server 200 via radio base station 300.

For example, communicator 110 receives the instruction information described above from server 200 or transmits the vehicle information described above to server 200.

The instruction information received by communicator 110 is outputted, for example, to determiner 150 and behavior controller 160.

Position estimator 120 is a device that estimates the current position of a vehicle. Examples of position estimator 120 include a Global Positioning System (GPS) receiver that receives a GPS signal, and a processor that performs estimation of the current position, the traveling direction, and/or the like of a vehicle based on a GPS signal(s).

Further, position estimator 120 may include a processor that performs position estimation by dead reckoning based on various information (for example, a detection result(s) of a gyro sensor and/or an acceleration sensor, the tire pulse, the steering angle, and/or the like). Thus, position estimator 120 can estimate the current position of a vehicle even in an area where it is difficult to receive a GPS signal (for example, indoors, in a tunnel, in an urban canyon, or the like).

Information indicating the current position estimated by position estimator 120 is outputted to determiner 150 and communication controller 170. Note that, current position information may include traveling direction information indicating the traveling direction of a vehicle.

Storer 130 is a device that stores various information.

For example, storer 130 stores a radio wave intensity map (which may also be referred to as “electric field intensity map”) indicating a radio wave intensity/radio wave intensities in a mobile communication network. The radio wave intensity map is data in which the radio wave intensity is defined for each position on a map. This radio wave intensity map is used by determiner 150 and behavior controller 160.

Information acquirer 140 is a device that acquires various information.

For example, information acquirer 140 acquires peripheral situation information, vehicle state information, big data collection information, and/or the like.

The peripheral situation information is information indicating a detection result(s) by various sensors (for example, a camera, RADAR, LiDAR, a sonar, and/or the like) that detect the peripheral situation of a vehicle. The vehicle state information is information indicating various states of an in-vehicle apparatus (for example, the steering angle, the rotation speed of a drive source, the gear ratio, the tire pulse, the remaining power amount, a measurement result(s) by an Inertial Measurement Unit (IMU), and/or the like). The big data collection information is, for example, a vehicle log including data that constitutes big data.

Various information acquired by information acquirer 140 is outputted to communication controller 170.

Determiner 150 is a device that executes various determinations.

Determiner 150 determines the strength of a received radio wave (this determination may also be referred to as determination of the communication quality) received by a vehicle (which may also be referred to as communicator 110) based on the current position of the vehicle estimated by position estimator 120 and a radio wave intensity map read from storer 130. This determination may also be referred to as determination of the communication quality.

In a case where a radio wave intensity defined in a radio wave intensity map is equal to or greater than a threshold set in advance, determiner 150 determines that the received radio wave is strong, and in a case where a radio wave intensity is less than the threshold, determiner 150 determines that the received radio wave is weak. Note that, the threshold is, for example, the minimum radio wave intensity which enables transmission and reception of information without hindrance (hereinafter, the same applies).

Determiner 150 can determine the strength of the current received radio wave (a received radio wave in a route along which a vehicle is currently traveling) based on the current position of the vehicle and a radio wave intensity map.

Further, determiner 150 can determine the strength of a future received radio wave (a received radio waves in a route along which a vehicle travels going forward) based on the current position of the vehicle, a travel route set in advance (for example, a route indicated by instruction information), and a radio wave intensity map.

Information indicating the strength of a received radio wave in a predetermined position (for example, a travel route along which a vehicle is currently traveling or a travel route along which a vehicle is scheduled to travel going forward) determined by determiner 150 is outputted to behavior controller 160 and communication controller 170.

Further, determiner 150 may, for example, cause notifier 180 to output an image indicating the current position and the travel route of a vehicle on a radio wave intensity map.

Notifier 180 is a device that performs notification to an occupant of a vehicle. As notifier 180, for example, a display mounted on the vehicle cabin can be mentioned, but the present disclosure is not limited thereto. For example, notifier 180 may be a speaker that outputs sound or a warning sound.

By viewing an image displayed at notifier 180, an occupant of a vehicle can grasp the strength of a received radio wave in the current position of the vehicle and the strength of a received radio wave in a route along which the vehicle travels going forward.

Behavior controller 160 (an example of the controller) is a device that executes control according to the behavior of a vehicle.

Basically, behavior controller 160 controls, based on instruction information received from communicator 110, various apparatuses (not illustrated; for example, a steering apparatus, an acceleration/deceleration apparatus, a braking apparatus, and/or the like) according to the behavior of a vehicle such that automatic driving is executed.

Further, as a characteristic operation in the present embodiment, behavior controller 160 controls the various apparatuses described above based on a result of determination by determiner 150. Specific examples of this control will be described later.

Communication controller 170 (an example of the controller) is a device that executes control according to the communication of a vehicle.

Basically, communication controller 170 controls communicator 110 such that communicator 110 transmits, to server 200, vehicle information including current position information received from position estimator 120, and peripheral situation information, vehicle state information, and big data collection information which are received from information acquirer 140.

Further, as a characteristic operation in the present embodiment, communication controller 170 controls communicator 110 based on a result of determination by determiner 150. Specific examples of this control will be described later.

Note that, among the components of information processing apparatus 100 illustrated in FIG. 1, for example, position estimator 120, storer 130, information acquirer 140, and notifier 180 may be provided outside information processing apparatus 100 (but inside a vehicle). That is, information processing apparatus 100 may be configured to include at least communicator 110, determiner 150, behavior controller 160, and communication controller 170. Alternatively, information processing apparatus 100 may be configured to include at least communicator 110, determiner 150, and one of behavior controller 160 and communication controller 170.

Further, in FIG. 1, the arrows indicating the destinations of information are illustrated between components, but even between components for which no arrows are illustrated, information input and output may be performed, in which case the illustration of the arrows is omitted.

An exemplary configuration of communication system 1 (information processing apparatus 100 and server 200) of the present embodiment has been described above.

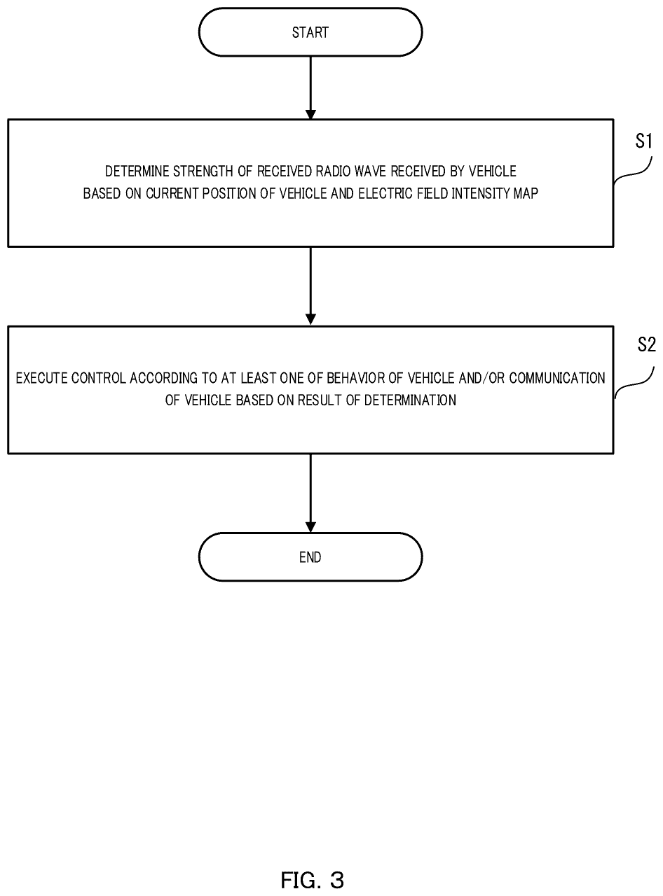

Next, exemplary operations of information processing apparatus 100 according to the present embodiment will be described with reference to FIG. 3. FIG. 3 is a flowchart illustrating exemplary operations of information processing apparatus 100. The flow in FIG. 3 starts, for example, when automatic driving of a vehicle is started.

First, information processing apparatus 100 determines the strength of a received radio wave received by of the vehicle based on the current position of the vehicle and an electric field intensity map (step S1).

Next, information processing apparatus 100 executes control according to at least one of the behavior of the vehicle and/or communication of the vehicle based on a result of the determination in step S1 (step S2).

Exemplary operations of information processing apparatus 100 according to the embodiment have been described above.

Next, specific examples of control by each of behavior controller 160 and communication controller 170 will be described.

### <Control Example 1>

Control Example 1 is an example of the control according to the behavior of a vehicle.

In a case where determiner 150 determines that the intensity of a received radio wave in the travel route of a vehicle is weak (specifically, less than a threshold set in advance), behavior controller 160 causes the vehicle to decelerate while the vehicle travels along the travel route in which the intensity of the received radio wave is weak (in other words, a travel route in which the intensity of the received radio wave is less than the threshold; hereinafter referred to as “weak radio wave route”).

The deceleration method here may be a method of reducing the current vehicle speed to a vehicle speed set in advance, a method of subtracting a vehicle speed, which is determined according to the current vehicle speed, from the current vehicle speed, or any other known method.

The travel route that is the target of the determination by determiner 150 (hereinafter, this travel route will be referred to as “determination target travel route”) may be a route along which a vehicle is scheduled to travel going forward (hereinafter this route will be referred to as “travel route along which a vehicle is scheduled to travel”) or a route along which a vehicle is currently traveling (hereinafter referred to as “route along which a vehicle is traveling”).

For example, in a case where the determination target travel route is a route along which a vehicle is traveling, behavior controller 160 may control an acceleration/deceleration apparatus (not illustrated; for example, a drive source, a transmission, or the like) such that the acceleration/deceleration apparatus immediately decelerates the vehicle.

Further, for example, in a case where the determination target travel route is a travel route along which a vehicle is scheduled to travel, behavior controller 160 may control the acceleration/deceleration apparatus such that the acceleration/deceleration apparatus decelerates the vehicle when the vehicle has reached a weak radio wave route or before the vehicle reaches a weak radio wave route.

Note that, before the execution of deceleration, behavior controller 160 may control notifier 180 such that notifier 180 performs notification to that effect. Thus, notifier 180 executes notification (for example, displaying an image or outputting a sound) to the effect that deceleration is executed. Thus, an occupant can know in advance that deceleration is executed.

In the present control example, a vehicle is decelerated in a weak radio wave route in which it is difficult to receive instruction information from server 200, and thus, it is possible to further enhance safety.

### <Control Example 2>

Control Example 2 is an example of the control according to the behavior of a vehicle.

In a case where determiner 150 determines that the intensity of a received radio wave in the travel route of a vehicle is weak, behavior controller 160 causes the vehicle to avoid the weak radio wave route and to travel along a strong radio wave route (a travel route in which the intensity of a received radio wave is equal to or greater than a threshold).

In this case, for example, behavior controller 160 may select a strong radio wave route based on the current position of the vehicle and a radio wave intensity map.

Further, for example, behavior controller 160 may select, among a plurality of radio wave-strong travel routes, a route in which the travel time of the vehicle is shortest, and may cause the vehicle to travel along the route.

Further, for example, behavior controller 160 may generate a travel route without including a point at which the intensity of a received radio wave is less than a threshold (generate a travel route such that the travel route passes only through a point at which the intensity of a received radio wave is equal to or greater than a threshold), and may cause the vehicle to travel along the travel route.

In the present control example, a vehicle is caused to avoid a weak radio wave route in which it is difficult to receive instruction information from server 200, and to travel along a strong radio wave route, and thus, it is possible to further enhance safety.

Note that, behavior controller 160 may control notifier 180 such that notifier 180 displays, on a radio wave intensity map, an image indicating the current position of a vehicle and the travel route thereof after a change.

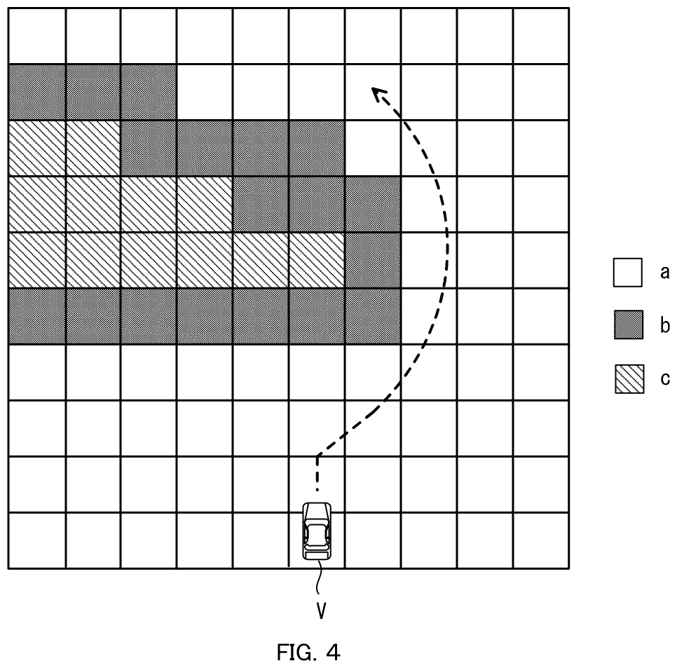

An example of this image is illustrated in FIG. 4. In FIG. 4, V represents a vehicle, a represents a region in which the received radio wave is strong, b represents a region in which the received radio wave is weaker than in region a, and c represents a region in which the received radio wave is weaker than in region b.

The dotted arrow illustrated in FIG. 4 indicates the travel route of the vehicle after a change. The travel route after the change is set to avoid regions b and c and to be in regions a in which the intensity of the received radio wave is strongest.

By displaying such an image, an occupant of a vehicle can recognize that the travel route of the vehicle has been changed to avoid regions in which the received radio wave is weak.

### <Control Example 3>

Control Example 3 is an example of the control according to the behavior of a vehicle.

In a case where determiner 150 determines that the intensity of a received radio wave in the travel route of a vehicle is weak, behavior controller 160 may select, among a plurality of weak radio wave routes, a route in which the travel time of the vehicle is shortest, and may cause the vehicle to travel along the route.

In the present control example, for example, in the case of a situation in which it is not possible to avoid traveling along a weak radio wave route (in a case where there is no region in which the intensity of the received radio wave is strong, and where it is not possible to change the travel route of a vehicle to a strong radio wave route), the time for the vehicle to travel along the weak radio wave route is minimized as much as possible, and thus, it is possible to further enhance safety.

Further, by combining the present control example with Control Example 1 described above, it is possible to further enhance safety.

### <Control Example 4>

Control Example 4 is an example of the control according to the behavior of a vehicle.

Here, a case where a vehicle performs automatic parking in a parking facility (for example, a large parking lot of a commercial facility or the like) including a plurality of parking spaces will be described as an example. Specifically, a case is assumed where an occupant of a vehicle gets off at the entrance of the parking facility, and thereafter, the vehicle travels from the entrance to, among the plurality of parking spaces, a vacant parking space, which is predetermined, by automatic driving, and performs automatic parking in the vacant parking space.

First, when the vehicle is present at the entrance of the parking facility, behavior controller 160 acquires vacancy information indicating the position(s) of an empty parking space(s). The vacancy information may be, for example, information received by communicator 110 from server 200 or another apparatus (not illustrated), or may be information acquired by another method.

Next, behavior controller 160 selects, based on the position(s) of the empty parking space(s), the current position of the vehicle, and a radio wave intensity map, an empty parking space in which the intensity of a received radio wave is equal to or greater than a threshold (hereinafter, this empty parking space will be referred to as “radio wave-strong parking space”), and selects a strong radio wave route from the entrance to the empty parking space.

Next, behavior controller 160 causes the vehicle to travel along the selected strong radio wave route and to be parked in the selected radio wave-strong parking space.

In the present control example, even in a case where the strength of the received radio wave varies for each parking space or route in a parking facility, a vehicle that performs automatic parking can travel along a strong radio wave route and can be parked in a radio wave-strong parking space, and thus, it is possible to further enhance safety.

### <Control Example 5>

Control Example 5 is an example of the control according to the communication of a vehicle.

In a case where determiner 150 determines that the intensity of a received radio wave in the travel route of a vehicle is weak, communication controller 170 changes a setting(s) according to communication with server 200 while the vehicle travels along a weak radio wave route.

Specifically, communication controller 170 changes the frame rate such that the frame rate is lower than the current value and/or changes the compression rate such that the compression rate is higher than the current value. Note that, communication controller 170 may change one of the frame rate and the compression rate, or may change both.

For example, in a case where the determination target travel route is a route along which a vehicle is traveling, communication controller 170 may control communicator 110 such that communicator 110 changes at least one of the frame rate and/or the compression rate immediately.

Further, for example, in a case where the determination target travel route is a travel route along which a vehicle is scheduled to travel, communication controller 170 may control communicator 110 such that communicator 110 changes at least one of the frame rate and/or the compression rate when the vehicle reaches a weak radio wave route.

In the present control example, a communication setting(s) is/are changed for a weak radio wave route in which it is difficult to receive instruction information from server 200, and thus, it is possible to stabilize the transmission and received of various information in a vehicle and to further enhance safety.

### <Control Example 6>

Control Example 6 is an example of the control according to the communication of a vehicle.

Communication controller 170 controls communicator 110 such that communicator 110 stores, in storer 130, information (for example, vehicle information) to be transmitted to server 200 while a vehicle travels along a weak radio wave route, and communicator 110 transmits the stored information to server 200 when the vehicle reaches a position in which the intensity of a received radio wave is equal to or greater than a threshold (for example, a strong radio wave route).

In the present control example, the transmission of information is not performed for a weak radio wave route in which it is difficult to transmit information to server 200, and the transmission of information is collectively performed when the communication quality is improved, and thus, it is possible to transmit information to server 200 surely and it is possible to further enhance safety.

Note that, any one of Control Examples 1 to 6 described above may be performed, or two or more thereof may be performed.

Specific examples of control by each of behavior controller 160 and communication controller 170 have been described above.

The information processing apparatus (for example, information processing apparatus 100) in the embodiment described above is an information processing apparatus that is mounted on a vehicle and includes a communicator (for example, communicator 110) that performs communication with an external apparatus (for example, server 200) via a mobile communication network, and the information processing apparatus is characterized by including: a determiner (for example, determiner 150) that performs determination of the strength of a received radio wave, which is received by the vehicle, based on the current position of the vehicle and a radio wave intensity map indicating a radio wave intensity in the mobile communication network; and a controller (for example, at least one of behavior controller 160 and/or communication controller 170) that performs control according to at least one of the behavior of the vehicle and/or the communication of the vehicle based on a result of the determination.

With this feature, it is possible to control the behavior of a vehicle and/or the communication of the vehicle in consideration of the communication quality, and thus, it is possible to achieve further improvement in, for example, safety and convenience.

Any of the embodiment described above is only illustration of an exemplary embodiment for implementing the present disclosure, and the technical scope of the present disclosure should not be construed limitedly thereby. That is, the present disclosure can be implemented in various forms without departing from the gist or the main features thereof.

Hereinafter, variations applicable to the embodiment will be described.

### [Variation 1]

Since a radio wave intensity map is data generated in advance, the intensity of a received radio wave may change to a value different from a value defined in the radio wave intensity map during automatic driving of a vehicle. In order to address such a situation, a vehicle (or an information processing apparatus) may be provided with a measurer (not illustrated) that measures the intensity of a received radio wave.

For example, during automatic driving of a vehicle, determiner 150 determines, as needed, whether the intensity of a received radio wave measured by the measurer (hereinafter, the intensity will be referred to as “measured intensity”) is equal to or greater than a threshold set in advance.

In a case where determiner 150 determines that the measured intensity is less than the threshold, behavior controller 160 first controls notifier 180 such that notifier 180 performs notification of switching from automatic driving to manual driving. Thus, notifier 180 executes notification (for example, displaying an image or outputting a sound) to the effect that the automatic driving is switched to the manual driving. Thus, an occupant is prepared to perform the manual driving.

Next, behavior controller 160 performs switching control from the automatic driving to the manual driving. Thus, various apparatuses (for example, a steering apparatus, an acceleration/deceleration apparatus, a braking apparatus, and/or the like) according to the behavior of the vehicle execute an operation(s) based on the manipulation by the occupant.

Further, behavior controller 160 may control notifier 180 such that notifier 180 displays a guide image. The guide image is, for example, an image indicating a route from the current position of a vehicle to a position in which the intensity of a received radio wave is equal to or greater than a threshold (for example, a strong radio wave route). Thus, the occupant who is executing manual operation can easily arrive at a position in which automatic operation can be resumed.

In the present variation, it is possible to address a situation in which a radio wave intensity defined in a radio wave intensity map changes, and thus, it is possible to further enhance safety.

### [Variation 2]

Another control may be performed using the measured intensity described in Variation 1.

For example, in a case where determiner 150 determines that a measured intensity is less than a threshold during automatic driving of a vehicle, behavior controller 160 may cause the vehicle to travel from the current position of the vehicle back to the departure point via the route along which the vehicle has traveled to the current position.

In the present variation, for example, around the current position of a vehicle, there is no position in which the intensity of a received radio wave is equal to or greater than a threshold and, even when a situation in which it is difficult for the vehicle to continue automatic driving occurs, the vehicle can return to the departure point by following the route along which the vehicle has traveled so far, and thus, it is possible to further enhance safety.

### [Variation 3]

In the embodiment, determiner 150 may determine the quality of radio communication based on a measured delay time of communication or a communication band, instead of or in addition to a radio wave intensity map, and behavior controller 160 may perform control according to at least one of the behavior of a vehicle and/or the communication of the vehicle, in the same manner, when the communication quality is high, as in a case where the intensity of a received radio wave is strong, and in the same manner, when the communication quality is low, as in a case where the intensity of a received radio wave is weak.

### [Variation 4]

In the embodiment, a case where the information that information processing apparatus 100 receives is instruction information for controlling a vehicle has been described as an example, but the present disclosure is not limited thereto, and the information may be other information (for example, content information or the like).

### [Variation 5]

In the embodiment, a case where position estimator 120, storer 130, and determiner 150 are provided in information processing apparatus 100 (vehicle) has been described as an example, but these may be provided in server 200.

In that case, various information (for example, peripheral situation information, vehicle state information, big data collection information, and/or the like) acquired by information acquirer 140 is transmitted from communicator 110 to server 200 under the control of communication controller 170, and is used for position estimation processing by position estimator 120.

Further, determination result information indicating a result of determination by determiner 150 is transmitted from communicator 210 to information processing apparatus 100 under the control of controller 230, and is inputted to behavior controller 160 and communication controller 170. Then, behavior controller 160 and communication controller 170 execute the various controls (Control Examples 1 to 6) described above based on the determination result information.

Note that, in Control Examples 1 to 3 and 5, the determination result information is, for example, information indicating that the intensity of a received radio wave in the travel route of a vehicle is less than a threshold set in advance. Further, in Control Example 2, the determination result information may include information indicating an image illustrating the current position of a vehicle and the travel route thereof after a change on a radio wave intensity map. Further, in Control Example 4, the determination result information is, for example, information indicating a route and the position of an empty parking space(s), where the route and the empty parking space(s) are where the intensity of a received radio wave is equal to or greater than a threshold set in advance. Further, in Control Example 5, the determination result information is, for example, information indicating the position of a travel route in which the intensity of a received radio wave is less than a threshold set in advance.

Further, in a case where the present variation is combined with Variation 1 or 2, communicator 210 may receive information indicating a measured intensity from information processing apparatus 100, and determiner 150 may determine whether the measured intensity is equal to or greater than a threshold set in advance. In this case, the determination result information that is transmitted to information processing apparatus 100 is information indicating that the measured intensity is less than the threshold. Further, the determination result information may include the above-described guide image, or may include position information on a strong radio wave route from the current position of a vehicle to the departure point thereof via the route along which the vehicle has traveled to the current position.

The information processing apparatus (for example, server 200) in the present variation described above is an information processing apparatus that includes a communicator (for example, communicator 210) that performs, via a mobile communication network, communication with an in-vehicle apparatus (for example, information acquirer 100) mounted on a vehicle, and the information processing apparatus is characterized by including: a determiner (for example, determiner 150) that determines the strength of a received radio wave, which is received by the vehicle, based on the current position of the vehicle and a radio wave intensity map indicating a radio wave intensity in the mobile communication network; and a controller (for example, controller 230) that controls the communicator such that the communicator transmits determination result information indicating a result of the determination to the in-vehicle apparatus, where the determination result information is used, in the in-vehicle apparatus, in control according to at least one of the behavior of the vehicle and/or the communication of the vehicle.

With this feature, it is possible to control the behavior of a vehicle and/or the communication of the vehicle in consideration of the communication quality, and thus, it is possible to achieve further improvement in, for example, safety and convenience.

Various variations have been described above. The above variations may be combined as appropriate.

The disclosure of Japanese Patent Application No. 2022-139085, filed on Sep. 1, 2022, including the specification, drawings and abstract, is incorporated herein by reference in its entirety.

### INDUSTRIAL APPLICABILITY

The information processing apparatus and the information processing method in the present disclosure are useful for a moving body that performs communication via a mobile communication network.

### REFERENCE SIGNS LIST

1 Communication system
100 Information processing apparatus
110 Communicator
120 Position estimator
130 Storer
140 Information acquirer
150 Determiner
160 Behavior controller
170 Communication controller
180 Notifier
200 Server
210 Communicator
220 Expander
230 Controller
300 Radio base station

1. An information processing apparatus that configured to be mounted on a vehicle, the information processing apparatus comprising:
a processor; and
a memory having instructions that, when executed by the processor, cause the processor to perform operations comprising:
performing communication with an external apparatus via a mobile communication network;
performing determination of a strength of a received radio wave based on a current position of the vehicle and a radio wave intensity map, the received radio wave being a radio wave received by the vehicle, the radio wave intensity map indicating a radio wave intensity in the mobile communication network; and
performing control according to at least one of a behavior of the vehicle and/or the communication of the vehicle based on a result of the determination.

2. The information processing apparatus according to claim 1, wherein
the processor to perform operations further comprising:
in a case where the determiner determines that an intensity of the received radio wave in a travel route of the vehicle is less than a threshold set in advance, causing the vehicle to decelerate while the vehicle travels along the travel route in which the intensity of the received radio wave is less than the threshold.

3. The information processing apparatus according to claim 1, wherein
the processor to perform operations further comprising:
in a case where the determiner determines that an intensity of the received radio wave in a travel route of the vehicle is less than a threshold set in advance,
causing the vehicle to avoid the travel route in which the intensity of the received radio wave is less than the threshold, and
causing the vehicle to travel along a travel route in which the intensity of the received radio wave is equal to or greater than the threshold.

4. The information processing apparatus according to claim 3, wherein
the processor to perform operations further comprising:
causing the vehicle to travel along, among a plurality of travel routes in which the intensity of the received radio wave is equal to or greater than the threshold, a travel route in which a travel time of the vehicle is shortest.

5. The information processing apparatus according to claim 1, wherein
the processor to perform operations further comprising:
in a case where the determiner determines that an intensity of the received radio wave in a travel route of the vehicle is less than a threshold set in advance,
causing the vehicle to travel along, among a plurality of travel routes in which the intensity of the received radio wave is less than the threshold, a travel route in which a travel time of the vehicle is shortest.

6. The information processing apparatus according to claim 1, wherein
the processor to perform operations further comprising:
in a case where the determiner determines that an intensity of the received radio wave in a travel route of the vehicle is less than a threshold set in advance,
changing at least one of a frame rate and/or a compression rate according to the communication while the vehicle travels along the travel route in which the intensity of the received radio wave is less than the threshold.

7. The information processing apparatus according to claim 1, wherein
the processor to perform operations further comprising:
in a case where an occupant of the vehicle gets off at an entrance of a parking facility including a plurality of parking spaces, and thereafter, the vehicle travels from the entrance to, among the plurality of parking spaces, a vacant parking space, which is a predetermined vacant parking space, by automatic driving and is parked in the vacant parking space, causing the vehicle to travel along a route from the entrance, and causes the vehicle to be parked in, among the plurality of parking spaces, a vacant parking space in which an intensity of the received radio wave is equal to or greater than a threshold, the route being a route in which the intensity of the received radio wave is equal to or greater than the threshold set in advance.

8. The information processing apparatus according to claim 1, wherein
the processor to perform operations further comprising:
accumulating that information to be transmitted to the external apparatus while the vehicle travels along a travel route in which an intensity of the received radio wave is less than a threshold set in advance, and
controlling that the accumulated information is transmitted to the external apparatus after the vehicle reaches a position in which the intensity of the received radio wave is equal to or greater than the threshold.

9. The information processing apparatus according to claim 1, wherein
the processor to perform operations further comprising:
measuring an intensity of the received radio wave; and
notifying notification to an occupant of the vehicle, wherein
in a case where the intensity of the received radio wave measured in the measuring is less than a threshold set in advance during automatic driving of the vehicle,
notifying that notification of switching from the automatic driving to manual driving, and
controlling that the automatic driving is switched to the manual driving.

10. The information processing apparatus according to claim 9, wherein
the processor to perform operations further comprising:
in a case where the notification is executed,
displaying an image indicating a route from a current position of the vehicle to a position in which the intensity of the received radio wave is equal to or greater than the threshold.

11. The information processing apparatus according to claim 1, wherein
the processor to perform operations further comprising:
measuring an intensity of the received radio wave, wherein
in a case where the intensity of the received radio wave measured in the measuring is less than a threshold set in advance during automatic driving of the vehicle,
controlling that the vehicle returns from a current position of the vehicle to a departure point via a route along which the vehicle has traveled to the current position.

12. The information processing apparatus according to claim 1, wherein:
the processor to perform operations further comprising:
transmitting vehicle information indicating a current position of the vehicle, a state of an in-vehicle apparatus of the vehicle, and a peripheral situation of the vehicle to the external apparatus, and
receiving instruction information from the external apparatus, the instruction information indicating an instruction for a behavior of the vehicle, the behavior being determined based on the vehicle information, and
controlling an automatic operation of the vehicle based on the instruction information.

13. An information processing method that uses a mobile communication network between an information processing apparatus configured to be mounted on a vehicle and an external apparatus, the information processing method comprising:
performing determination of a strength of a received radio wave based on a current position of the vehicle and a radio wave intensity map, the received radio wave being a radio wave received by the vehicle, the radio wave intensity map indicating a radio wave intensity in the mobile communication network; and
performing control according to at least one of a behavior of the vehicle and/or the communication of the vehicle based on a result of the determination.

14. The information processing method according to claim 13, wherein
in a case where it is determined that an intensity of the received radio wave in a travel route of the vehicle is less than a threshold set in advance,
causing the vehicle to decelerate while the vehicle travels along the travel route in which the intensity of the received radio wave is less than the threshold.

15. The information processing method according to claim 13, wherein
in a case where it is determined that an intensity of the received radio wave in a travel route of the vehicle is less than a threshold set in advance,
causing the vehicle to avoid the travel route in which the intensity of the received radio wave is less than the threshold, and
causing the vehicle to travel along a travel route in which the intensity of the received radio wave is equal to or greater than the threshold.

16. The information processing method according to claim 13, wherein
in a case where an occupant of the vehicle gets off at an entrance of a parking facility including a plurality of parking spaces, and thereafter, the vehicle travels from the entrance to, among the plurality of parking spaces, a vacant parking space, which is a predetermined vacant parking space, by automatic driving and is parked in the vacant parking space, causing the vehicle to travel along a route from the entrance, and that the vehicle is parked in, among the plurality of parking spaces, a vacant parking space in which an intensity of the received radio wave is equal to or greater than a threshold, the route being a route in which the intensity of the received radio wave is equal to or greater than the threshold set in advance.

17. The information processing method according to claim 13, further comprising:
accumulating that information to be transmitted to the external apparatus while the vehicle travels along a travel route in which an intensity of the received radio wave is less than a threshold set in advance, and
controlling that the accumulated information is transmitted to the external apparatus when the vehicle reaches a position in which the intensity of the received radio wave is equal to or greater than the threshold.

18. The information processing method according to claim 13, further comprising:
measuring an intensity of the received radio wave,
notifying that notification to an occupant of the vehicle, and
in a case where the intensity of the received radio wave measured in the measuring is less than a threshold set in advance during automatic driving of the vehicle,
notifying that notification of switching from the automatic driving to manual driving is performed, and
controlling that the automatic driving is switched to the manual driving.

19. The information processing method according to claim 13, further comprising:
in a case where the notification is executed,
displaying an image indicating a route from a current position of the vehicle to a position in which the intensity of the received radio wave is equal to or greater than the threshold.

20. The information processing method according to claim 13, further comprising:
measuring an intensity of the received radio wave, and
in a case where the intensity of the received radio wave measured in the measuring is less than a threshold set in advance during automatic driving of the vehicle,
controlling that the vehicle returns from a current position of the vehicle to a departure point via a route along which the vehicle has traveled to the current position.
